(19) United States
(12) Patent Application Publication
(10) Pub. No.: US 2024/0098402 A1
(43) Pub. Date: Mar. 21, 2024

(54) LOUDSPEAKER AND AUDIO SYSTEM

(71) Applicant: SUZHOU SONAVOX ELECTRONICS CO., LTD., Suzhou, Jiangsu (CN)

(72) Inventors: Peng GAO, Suzhou, Jiangsu (CN); Guoqiang CHAI, Suzhou, Jiangsu (CN)

(21) Appl. No.: 18/257,095

(22) PCT Filed: Jul. 1, 2021
(86) PCT No.: PCT/CN2021/103912

§ 371 Date: Jun. 12, 2023

(30) Foreign Application Priority Data
Jan. 18, 2021 (CN) 202110062516.9

(51) Int. Cl. H04R 1/24; H04R 1/02; H04R 7/12; H04R 9/02; H04R 9/04; H04R 9/06

(52) U.S. Cl. CPC H04R 1/24; H04R 1/025; H04R 7/12; H04R 9/025; H04R 9/045; H04R 9/06; H04R 2400/11; H04R 2499/13

(57) ABSTRACT

Discloses are a loudspeaker and an audio system. The loudspeaker includes a frame, a diaphragm for vibrating to produce sound and arranged on the frame, a voice coil for driving the diaphragm to vibrate, a magnetic circuit for driving the voice coil to vibrate, and an annular member arranged at an upper end portion of the voice coil and connected to the diaphragm. The magnetic circuit is arranged on the frame, and the magnetic circuit is provided with a magnetic gap for a lower end portion of the voice coil to insert in. The loudspeaker can achieve more prominent low frequency at a low cost during working, without overlap of frequency response when working together with a tweeter.

This application is the U.S. National Phase under 35. U.S.C. § 371 of International Application PCT/CN2021/103912, filed Jul. 1, 2021, which claims priority from Chinese Patent Application No. CN 202110062516.9 filed on Jan. 18, 2021. The disclosures of the above-described applications are hereby incorporated by reference in their entirety.

### FIELD OF TECHNOLOGY

The present disclosure relates to the field of loudspeakers, specifically to a loudspeaker and an automobile audio system, in particular to a vehicle-mounted loudspeaker and a vehicle-mounted audio system.

### BACKGROUND

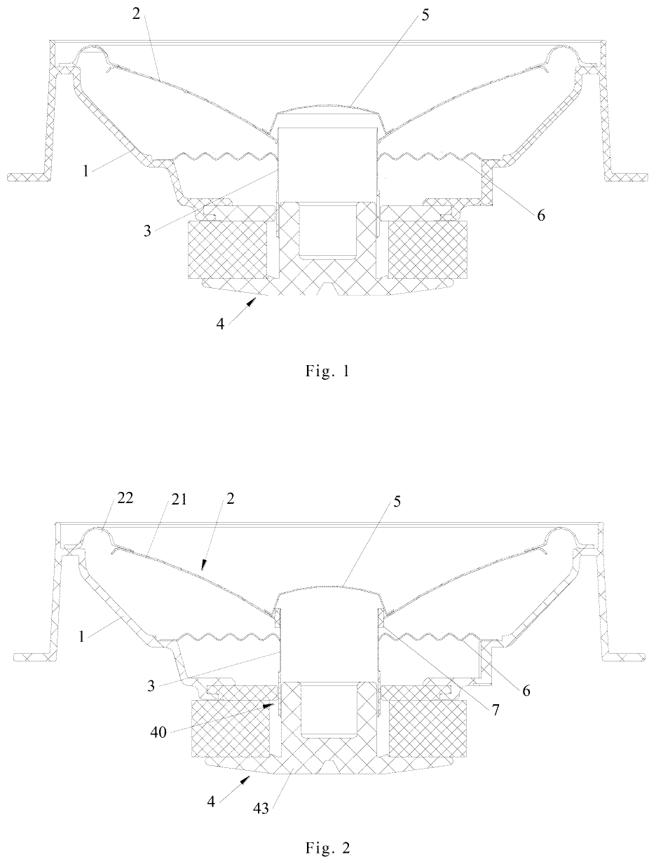

FIG. 1 is a schematic diagram of a conventional loudspeaker, which may be a subwoofer, woofer, or midrange loudspeaker. Referring to FIG. 1, a conventional loudspeaker includes a frame 1, a diaphragm 2 arranged on the frame 1, and a voice coil 3 driven to vibrate by a magnetic circuit 4, wherein an upper end portion of the voice coil 3 is directly fixed to the diaphragm 2 by bonding or the like. For example, a mounting hole is opened in the middle of the diaphragm 2, the voice coil 3 is arranged in the mounting hole, and an outer wall of the voice coil 3 is bonded to the diaphragm 2. A dust cap 5 covering the voice coil 3 is further fixed on the diaphragm 2. In some application scene, such as vehicle-mounted audio systems for in-vehicle sound reproduction, such loudspeakers are combined with tweeters to work together. When working with a tweeter, the frequency responses will overlap, and the levels of sound will not be clear enough. In order to solve this problem, a low-pass filter is designed on the driver circuit board of the loudspeaker to eliminate the overlap of frequency response of the subwoofer, woofer or midrange loudspeaker and the tweeter. However, this solution has high cost, complicated loudspeaker manufacturing process, and low cost performance.

### SUMMARY

An aspect relates to a loudspeaker, which can achieve more prominent low frequency at a low cost during working, without overlap of frequency response when working together with a tweeter.

Another aspect relates to an audio system, which can make the sound natural and clean, and has a clearly layering at a lower cost without providing a low-pass filter in the circuit.

A first aspect of the present disclosure provides a loudspeaker, comprising:
a frame;
a diaphragm for vibrating to produce sound, and arranged on the frame;
a voice coil for driving the diaphragm to vibrate; and
a magnetic circuit for driving the voice coil to vibrate, the magnetic circuit being arranged on the frame, and the magnetic circuit being provided with a magnetic gap for a lower end portion of the voice coil to insert in;
the loudspeaker further comprises:
an annular member arranged at an upper end portion of the voice coil and connected to the diaphragm.

In an embodiment, the annular member is coaxial with the voice coil. That is, the center line of the annular member and the center line of the voice coil coincide with each other.

In an embodiment, the annular member is sleeved on the upper end portion of the voice coil.

In an embodiment, the diaphragm is provided with a mounting hole, the upper end portion of the voice coil is inserted into the mounting hole, an inner surface of the annular member is connected to an outer surface of the voice coil, and the outer surface of the annular member is connected to a hole wall of the mounting hole.

In an embodiment, the inner surface of the annular member is bonded to the outer surface of the voice coil.

In an embodiment, the outer surface of the annular member is bonded to the hole wall of the mounting hole.

In an embodiment, the lower portion of the annular member is inserted into the upper end portion of the voice coil.

In an embodiment, the annular member is formed by curing silane glue, which can be directly bonded to the voice coil and the diaphragm.

In an embodiment, the loudspeaker further comprises a dust cap, the dust cap is connected to the diaphragm and covers over the mounting hole.

In an embodiment, the material of the annular member is selected from paper or rubber. In a preferred embodiment, the material of the annular member is one of paper, non-foamed rubber, foamed rubber, silica gel and soft glue.

In an embodiment, the annular member is a flexible member. Further, the material of the annular member is silane glue.

In an embodiment, the shape of the annular member is a hollow cylinder as a whole.

In an embodiment, the height of the annular member (dimension in the axial direction) is 0.5-5 mm Herein, “axial” specifically refers to the direction along the center line of the voice coil.

In an embodiment, the loudspeaker is a subwoofer, a woofer, or a midrange loudspeaker. When used as a woofer, it can be an independent woofer, or a woofer unit in a coaxial loudspeaker with two or more sound channels.

In an embodiment, the loudspeaker is a vehicle-mounted loudspeaker.

In an embodiment, the magnetic circuit is an external magnetic configuration. In another embodiment, the magnetic circuit is an internal magnetic configuration or an inverted magnetic configuration.

In an embodiment, the magnetic circuit adopts ferrite, neodymium iron boron or rubidium nickel cobalt magnetic steel.

In an embodiment, the voice coil is connected to the diaphragm only through a single annular member. That is, there is no direct contact between the voice coil and the diaphragm, and only indirect connection through the annular member.

A second aspect of the present disclosure provides an audio system comprising a tweeter, the audio system further comprises at least one of a subwoofer, a woofer, and a midrange loudspeaker, and the subwoofer, the woofer or the midrange loudspeaker is a loudspeaker as described above.

In an embodiment, the audio system is a vehicle-mounted audio system. In another embodiment, the audio system is a home audio system.

A third aspect of the present disclosure provides a coaxial loudspeaker comprising a tweeter unit and a woofer unit, and the woofer unit is a loudspeaker as described above.

The present disclosure adopts the above solutions, and has the following advantages over the prior art:

in the loudspeaker of the present disclosure, the upper end portion of the voice coil is connected to the diaphragm through the annular member, so that the mid-frequency and high-frequency bands of the loudspeaker can be rapidly decreased, so that the low frequency is more prominent when the loudspeaker works, and the frequency response is not overlapped when working with the tweeter, so that the sound is relatively natural and clean, and has a clearly layering; under this premise, the loudspeaker and sound system have low cost, high cost performance, and relatively simple manufacturing and process operations.

### BRIEF DESCRIPTION

For more clearly explaining the technical solutions in the embodiments of the present disclosure, the accompanying drawings used to describe the embodiments are simply introduced in the following. Apparently, the below described drawings merely show a part of the embodiments of the present disclosure, and those skilled in the art can obtain other drawings according to the accompanying drawings without creative work.

FIG. 1 is a schematic diagram of a conventional loudspeaker;

FIG. 2 is a schematic diagram of a loudspeaker according to an embodiment of the present disclosure;

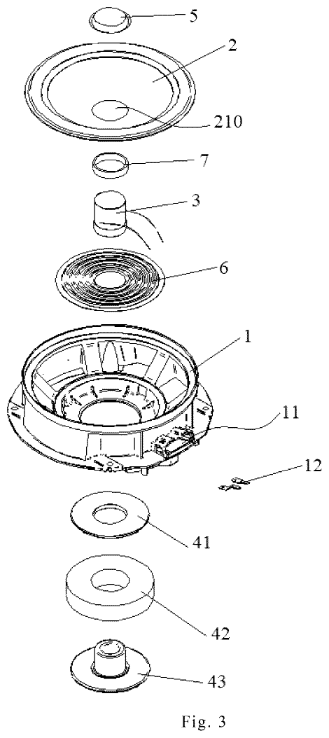

FIG. 3 is an exploded diagram of a loudspeaker according to an embodiment of the present disclosure;

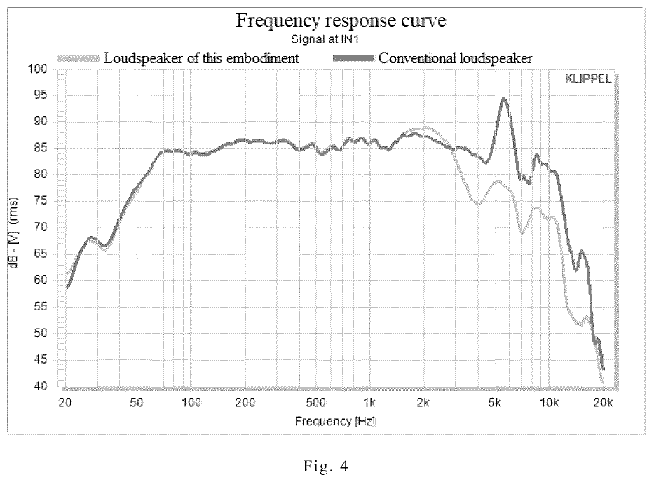

FIG. 4 is a comparison diagram of frequency response curves of a conventional loudspeaker and a loudspeaker according to an embodiment of the present disclosure.

### REFERENCE NUMBERS

1—frame; 11—connection port; 12—solder piece; 2—diaphragm; 21—cone body; 210—mounting hole; 22—edge ring; 3—voice coil; 4—magnetic circuit; 40—magnetic gap; 41—front sheet; 42—magnetic steel; 43—rear sheet; 5—dust cap; 6—damper; 7—annular member.

### DETAILED DESCRIPTION

In the following, the preferable embodiments of the present disclosure are explained in detail combining with the accompanying drawings so that the advantages and features of the present disclosure can be easily understood by the skilled persons in the art. It should be noted that the explanation on these implementations is to help understanding of the present disclosure, and is not intended to limit the present disclosure. Further, the technical features involved in the various embodiments of the present disclosure described below may be combined with each other if they do not conflict with each other.

In the description of the present disclosure, it should be noted that the orientation or positional relationship indicated by the terms “upper”, “lower”, “inner”, “outer”, and the like is based on the orientation or positional relationship shown in the accompanying drawings, is only for the convenience of describing the present disclosure and simplifying the description, rather than indicating or implying that the indicated device or element must have a particular orientation, be constructed and operate in a particular orientation, and therefore should not be construed as limiting the present disclosure.

In the description of the present disclosure, it should be noted that, unless otherwise expressly specified and limited, the terms “mount”, “communicate”, and “connect” should be understood in a broad sense, for example, it may be fixedly connected or detachably connected, or integrated; it may be mechanically connected or electrically connected; it can be directly connected or indirectly connected through an intermediate medium, or it can be the internal communication of two elements. For those of ordinary skill in the art, the specific meanings of the above terms in the present disclosure can be understood according to specific situations.

It should be further understood that in the present disclosure, “plurality” refers to two or more, and other quantifiers are similar. The singular forms “a”, “said”, and “the” are intended to include the plural forms as well, unless the context clearly dictates otherwise.

The endpoints and any values of the ranges disclosed herein are not limited to the precise ranges or values, and these ranges or values should be understood to include values close to these ranges or values. For ranges of value, between the end values of each range, between the end values of each range and individual point values, and between individual point values can be combined with each other to obtain one or more new ranges of value, and these ranges of value should be considered as specifically disclosed herein.

This embodiment provides a loudspeaker, specifically a vehicle-mounted loudspeaker, which can be used as a subwoofer, a woofer or a midrange loudspeaker of a vehicle-mounted audio system. Referring to FIG. 2 to FIG. 3, the loudspeaker comprises a frame 1, a diaphragm 2, a voice coil 3 and a magnetic circuit 4. The frame 1 is used to support the internal components of the entire loudspeaker and to be connected to the components of the automobile, and the middle portion of the frame 1 is hollowed out to accommodate the diaphragm 2, the voice coil 3 and the magnetic circuit 4. The diaphragm 2 is used for vibrating to produce sound, and the diaphragm 2 is arranged on the frame 1. The voice coil 3 is used to drive the diaphragm 2 to vibrate. The magnetic circuit 4 is used to drive the voice coil 3 to vibrate, the magnetic circuit 4 is arranged on the frame 1, and the magnetic circuit 4 has a magnetic gap 40 for the lower end portion of the voice coil 3 to insert in. The loudspeaker further comprises an annular member 7, and the annular member 7 is disposed on the upper end portion of the voice coil 3 and connected to the diaphragm 2. There is no direct contact between the voice coil 3 and the diaphragm 2, and only indirect connection through the annular member 7.

The diaphragm 2 comprises a cone body 21 and an edge ring 22 surrounding the periphery of the cone body 21, the edge ring 22 is fixedly connected to the upper surface of the frame 1, and the cone body 21 is located in the frame 1. The diameter of the cone body 21 gradually decreases from top to bottom, and the edge ring 22 is connected to the upper edge of the cone body 21; specifically, it can be bonded to the upper edge of the cone body 21, and the edge ring 22 is bonded to the upper surface of the frame 1. A mounting hole 210 for mounting the voice coil 3 is arranged at the lower portion (i.e., the middle position) of the cone body 21.

The lower end portion of the voice coil 3 is a coil portion, which is inserted into the magnetic gap 40 of the magnetic circuit 4 and can vibrate up and down by electromagnetic action. The upper portion of the voice coil 3 is a skeleton, which is fixed on the diaphragm 2 through the annular member. A connecting port 11 is opened on the side surface of the frame 1, and a pair of solder pieces 12 are embedded in the connecting port 11, and the positive and negative poles of the leads of the voice coil 3 are connected to the pair of solder pieces 12 to facilitate the input of external audio signals.

The annular member 7 is coaxial with the voice coil 3. That is, the center line of the annular member 7 and the center line of the voice coil 3 coincide with each other. Further, the annular member 7 is sleeved on the upper end portion of the voice coil 3. The upper end portion of the voice coil 3 is inserted into the mounting hole 210, the inner surface of the annular member 7 is connected to the outer surface of the voice coil 3, and the outer surface of the annular member 7 is connected to the hole wall of the mounting hole 210. Specifically, the inner surface of the annular member 7 is bonded to the outer surface of the voice coil 3; the outer surface of the annular member 7 is connected to, for example bonded to the hole wall of the mounting hole 210. In some other embodiments, the lower portion of the annular member 7 is inserted into the upper end portion of the voice coil 3.

The material of the annular member 7 is one of paper, non-foamed rubber, foamed rubber, and silane glue. In this embodiment, the annular member 7 is formed by curing silane glue, which can be directly bonded to the voice coil 3 and the diaphragm 2, and the annular member 7 thus formed is a flexible material, which connects the diaphragm 2 and the voice coil 3 flexibly, which helps to further improve the performance.

The shape of the annular member 7 is a hollow cylinder as a whole. The size (height) of the annular member 7 in the axial direction (the up-down direction in FIG. 2) is 0.5-5 mm.

The loudspeaker further comprises a dust cap 5, the dust cap 5 is connected to the diaphragm 2 and covering over the mounting hole 210.

In this embodiment, the magnetic circuit 4 is an external magnetic structure. The magnetic circuit 4 comprises a front sheet 41, a magnetic steel 42 and a rear sheet 43, the middle portion of the rear sheet 43 has a cylindrical portion extending upward, the magnetic steel 42 and the front sheet 41 are sequentially sleeved on the cylindrical portion from bottom to top, and there is a gap between the cylindrical portion, the front sheet 41 and the magnetic steel 42, that is, the above-mentioned magnetic gap 40 is formed. The magnetic steel 42 adopts ferrite, neodymium iron boron or rubidium nickel cobalt magnetic steel 42. In another embodiment, the magnetic circuit may be an internal magnetic structure.

The loudspeaker further comprises a damper 6, the damper 6 is sleeved on the voice coil 3, and the outer edge of the damper 6 is fixed on the frame 1 to prevent the voice coil 3 from shaking horizontally, so that the voice coil 3 only vibrate up and down.

The present embodiment further provides a vehicle-mounted audio system, which comprises a tweeter. The vehicle-mounted audio system further comprises at least one of a subwoofer, a woofer, and a midrange loudspeaker, and the subwoofer, the woofer or the midrange loudspeaker is a loudspeaker as described above.

This embodiment further provides an audio system comprising a coaxial loudspeaker with two or more sound channels, the coaxial loudspeaker comprises a tweeter unit and a woofer unit, and the woofer unit adopts a loudspeaker as described above.

In this embodiment, the voice coil 3 is connected to the diaphragm 2 through the annular member 7, so that the mid-frequency and high-frequency bands of the loudspeaker is rapidly decreased, so that the low frequency is more prominent when the loudspeaker works, and the frequency response is not overlapped when working with the tweeter, so that the sound is relatively natural and clean, and has a clearly layering. The loudspeaker using the ring member 7 can avoid using the conventional LC circuit low-pass filter (which needs to be arranged on the driver circuit board of the audio system) when it is combined with the tweeter to form the vehicle-mounted audio system, and have low cost and high cost performance, and relatively simple manufacturing and process operations.

FIG. 4 shows a comparison diagram of frequency response curves of a conventional loudspeaker and a loudspeaker of this embodiment. Referring to FIG. 4, the curve with darker color is the frequency response curve of the conventional loudspeaker, and the curve with lighter color is the frequency response curve of the loudspeaker of this embodiment. The effective frequency range of conventional loudspeakers is 50-11000 Hz, which is too wide for woofers, and is not conducive to the join to tweeters (too much sound in the middle and high frequencies will be very noisy). The effective frequency range of the loudspeaker in this embodiment is 50-3000 Hz, and it can be seen from the comparison of the frequency response curves that the frequency division point is around 3000 Hz by providing the annular member 7; it can effectively filter out the excess mid-high frequency of 3000-11000 Hz, in which the maximum sound pressure drop around 5500 Hz is 15 dB. If a conventional LC circuit is used to filter down by 12 dB, a second-order filter is required, the cost is about 3 yuan, and the ring member of the loudspeaker in this embodiment costs at most 0.5 yuan, so a single loudspeaker can save 2.5 yuan.

The embodiments described above are only for illustrating the technical concepts and features of the present disclosure, and are intended to make those skilled in the art being able to understand the present disclosure and thereby implement it, and should not be concluded to limit the protective scope of this disclosure.

1. A loudspeaker, comprising:
a frame;
a diaphragm for vibrating to produce sound, and arranged on the frame;
a voice coil for driving the diaphragm to vibrate;
a magnetic circuit for driving the voice coil to vibrate, the magnetic circuit being arranged on the frame, and the magnetic circuit being provided with a magnetic gap for a lower end portion of the voice coil to insert in; and
an annular member arranged at an upper end portion of the voice coil and connected to the diaphragm.

2. The loudspeaker according to claim 1, wherein the annular member is coaxial with the voice coil.

3. The loudspeaker according to claim 1, wherein the annular member is sleeved on the upper end portion of the voice coil.

4. The loudspeaker according to claim 3, wherein the diaphragm comprises a mounting hole, the upper end portion of the voice coil is inserted into the mounting hole, an inner surface of the annular member is connected an outer surface of the voice coil, and an outer surface of the annular member is connected to a hole wall of the mounting hole.

5. The loudspeaker according to claim 4, wherein the inner surface of the annular member is bonded to the outer surface of the voice coil; and/or the outer surface of the annular member is bonded to the hole wall of the mounting hole.

6. The loudspeaker according to claim 4, wherein the loudspeaker further comprises a dust cap, the dust cap is connected to the diaphragm and covers over the mounting hole.

7. The loudspeaker according to claim 1, wherein a lower portion of the annular member is inserted into the upper end portion of the voice coil.

8. The loudspeaker according to claim 1, wherein material of the annular member is selected from paper, non-foamed rubber, and foamed rubber; or the annular member is formed by curing silane glue.

9. The loudspeaker according to claim 1, wherein the annular member is a flexible member.

10. The loudspeaker according to claim 1, wherein the annular member is in a shape of a hollow cylinder.

11. The loudspeaker according to claim 10, wherein a height of the annular member is 0.5-5 mm.

12. The loudspeaker according to claim 1, wherein the voice coil is connected to the diaphragm through the annular member.

13. The loudspeaker according to claim 1, wherein the loudspeaker is a subwoofer, a woofer, or a midrange loudspeaker.

14. The loudspeaker according to claim 1, wherein the loudspeaker is a vehicle-mounted loudspeaker.

15. An audio system comprising a tweeter, the audio system further comprising at least one of a subwoofer, a woofer, and a midrange loudspeaker, wherein the subwoofer, the woofer, or the midrange loudspeaker is a loudspeaker according to claim 1.

16. The audio system according to claim 15, wherein the audio system is a vehicle-mounted audio system.

17. A coaxial loudspeaker comprising a tweeter unit and a woofer unit, wherein the woofer unit comprises a loudspeaker according to claim 1.
